(19) United States
(12) Patent Application Publication
(10) Pub. No.: US 2010/0067686 A1
(43) Pub. Date: Mar. 18, 2010

(54) SHARED KEY BLOCK CIPHER APPARATUS, ITS METHOD, ITS PROGRAM AND RECORDING MEDIUM

(76) Inventor: Kazuhiro Minematsu, Tokyo (JP)

Correspondence Address: Mr. Jackson Chen, 6535 N. STATE HWY 161, IRVING, TX, 75039, US

(21) Appl. No.: 12/447,523

(22) PCT Filed: Sep. 26, 2007
(86) PCT No.: PCT/JP2007/068622

§ 371 Date: Apr. 28, 2009

(30) Foreign Application Priority Data
Oct. 30, 2006 (JP) 2006-294536

(51) Int. Cl. H04L 9/28; G06F 7/58

(52) U.S. Cl. 380/28; 708/250

(57) ABSTRACT

There is provided a shared key block cipher apparatus, its method, its program, and a recording medium in which a block cipher having a large block size is constructed by combining highly secure cipher processing with high-speed cipher processing. In a block cipher having a large block size, a plain text is permutated using a universal hash function, one block of the result is ciphered by a block cipher having high safety, and an output obtained from a pseudo random number generator by inputting thereto a sum of the input and the output of the block cipher is added to a remaining block. Finally, a permutation using a universal hash function is applied.

### TECHNICAL FIELD

The present invention relates to a shared key block cipher apparatus, its method, its program, and a recording medium, and in particular, to a shared key block cipher apparatus, its method, its program, and a recording medium in which a block cipher having a large block size is constructed by use of a combination of highly secure cipher processing and high-speed cipher processing.

### RELATED ART

There have been recently known many approaches to construct a new cipher by using, as cipher components, cipher processing such as a block cipher and a hash function.

For example, regarding the file cipher, to facilitate processing of ciphered data in a sector unit, research is being conducted to construct a block cipher having a larger block size (such as 512 bits) corresponding to the sector size by using a block cipher having a standard block size (such as 128 bits).

Ordinarily, the combination of such cipher components has been required to guarantee security of the cipher components against a chosen plain text attack and enough security of a cipher constructed anew using the cipher components. In this regard, the enough security of a cipher constructed anew indicates, if the cipher constructed anew is a block cipher, security against the chosen plain text attack or security against an attack including an arbitrary combination of the chosen plain text attack and a chosen cipher text attack. If the cipher constructed anew is a stream cipher, it indicates security against a chosen plain text attack in a model in which an attacker can select an initial vector.

Incidentally, in a situation of a method employing only components safe against the chosen plain text attack or the chosen cipher text attack, throughput (the amount of processing per time unit) constructed anew cannot exceed throughput of the cipher components.

In contrast thereto, there exists a method which does not adopt “employing only components safe against the chosen plain text attack or the chosen cipher text attack”, but adopts “combining components safe against the chosen plain text attack with components safe against known plain text attack” (reference is to be made to, for example, Patent Document 1 and Non-patent Document 2).

In this connection, according to Patent Document 1 and Non-patent Document 2 described above, a stream cipher is constructed by expanding an output of a block cipher using a hash function and a stream cipher. Also, Patent Document 1 above describes that a stream cipher constructed anew is secure by using a block cipher safe against the chosen plain text attack and a hash function and a stream cipher which are safe against the known plain text attack.

The known plain text attack is an attack of a class weaker than the chosen plain text attack. Cipher components safe against the known plain text attack are of lower requirements for safety and hence can be expected to operate at a higher speed than cipher components safe against the chosen plain text or cipher text attacks. Additionally, according to Patent Document 1 above, by using a block cipher safe against the chosen plain text attack, and a hash function and a stream cipher safe against the known plain text attack, it is possible to almost equalize the throughput of the cipher constructed anew to the throughput of the cipher components safe against the known plain text attack.

Also, Non-patent Document 1 describes a scheme to construct an arbitrary block cipher having a large block size by combining the block cipher safe against the chosen plain text/cipher text attack with a cipher (needs not necessarily to be a block cipher) safe against the known plain text attack. Consider a situation wherein the method described in the document is implemented by use of a block cipher E safe against an n-bit-block chosen cipher text attack and cipher F safe against an n-bit-block known plain text attack. In a case wherein the object to be constructed is a block cipher safe against an nm-bit-block-size chosen plain text attack, the number of calls for E is one and that of calls for F is m−1. Also, In a case wherein the object to be constructed is a block cipher safe against an nm-bit-block-size chosen cipher text attack, the number of calls for E is two and that of calls for F is m−2.

Patent Document 1: U.S. Pat. No. 6,104,811
Non-patent Document 1: Kazuhiko Minematsu, Yukiyasu Tsunoo: Hybrid Symmetric Encryption Using Known-Plaintext Attack-Secure Components. pp. 242-260, Information Security and Cryptology-ICISC 2002, 5th International Conference Seoul, Korea, Nov. 28-29, 2002. Lecture Notes in Computer Science 2587 Springer 2003, ISBN 3-540-00716-4

### Non-patent Document 2: W. Aiello, R. Rajagopalan and V. Venkatesan, High-speed Pseudorandom Number Generation With Small Memory, Fast Software Encryption, 6th International Workshop, FSE '99, Lecture Notes in Computer Science; Vol. 1636, March 1999

Non-patent Document 3: IEEE Computer Society Security in Storage Working Group (SISWG), Draft Proposal for Tweakable Wide-block Encryption, http://www.siswg.org/docs/EME-AES-03-22-2004.pdf
Non-patent Document 4: S. Halevi and H. Krawczyk, MMH: Software Message Authentication in the Gbit/second rates, Fast Software Encryption, 4th international Workshop, FSE '97, Lecture Notes in Computer Science; Vol. 1267, February 1997
Non-patent Document 5: The Poly 1305-AES Message Authentication Code, D. J. Bernstein, Fast Software Encryption, FSE 2005, Lecture notes in computer science 3557, pp. 32-49, Springer, 2005.
Non-patent Document 6: J. Daemen, V. Rijmen, “AES Proposal: Rijdael”, AES submission, 1998.
Non-patent Document 7: U. Maurer and Johan Sjoedin, From Known-Plaintext to Chosen-Ciphertext Security, Cryptology ePrint Archive 2006/071, http://eprint.iacr.org/2006/071.pdf

### Non-patent Document 8: P. Rogaway and D. Coppersmith, A Software-Optimized Encryption Algorithm, Fast Software Encryption, 1st International Workshop, FSE '93, Lecture Notes in Computer Science; Vol. 809, February 1993.

### DISCLOSURE OF THE INVENTION

### Problem to be Solved by the Invention

However, the inventions described above are accompanied by problems as below.

In the above Non-patent Document 1, to construct a block cipher having a large block size safe against the chosen cipher text attack, a block cipher having a small block size, which is a constituent component of the block cipher, safe against a chosen cipher text attack is required to be called twice, and it is required to change the respective keys.

Furthermore, that the block cipher is safe against the chosen cipher text attack and the block size can be set to an arbitrary value is a requirement desired for the disk sector cipher as described in Non-patent Document 3.

It is therefore an exemplary object of the present invention, which has been devised in consideration of the condition described above, to propose a shared key block cipher apparatus, its method, its program, and a recording medium which provide, in an efficient method, an arbitrary block cipher having a large block size safe against the chosen cipher text attack by combining a fixed-length block cipher E safe against the chosen cipher text attack with a cipher F (not necessarily limited to a block cipher) safe against the known plain text attack. Specifically, although the fixed-length block cipher E is required to be called twice in Non-patent Document 1, the fixed-length block cipher E is called only once in the present invention.

### Means for Solving the Problem

A first exemplary aspect of the present invention provides a shared key block cipher apparatus including first hash means for dividing a plain text to be ciphered into a first block and a second block, compressing the divided first block by a hash function, adding the compressed first block to the second block to generate a unitary block intermediate text, and outputting the generated unitary block intermediate text and the first block; unitary block cipher means for ciphering the unitary block intermediate text to generate a unitary block intermediate cipher text; pseudo random number generating means for generating an intermediate random number based on a sum of the unitary block intermediate text and the unitary block intermediate cipher text; adding means for adding the intermediate random number to the first block to output a first addition result; second hash means for compressing the first addition result by a hash function and calculating a cipher text using the compressed first addition result and the unitary block intermediate cipher text; and cipher text output means for outputting the cipher text outputted from the second hash means.

A second exemplary aspect of the present invention provides the shared key block cipher apparatus in accordance with the first exemplary aspect, wherein the second hash means permutes the unitary block intermediate cipher text by a hash function, concatenates a second addition result obtained by adding the permuted unitary block intermediate cipher text to the compressed first addition result with the first addition result, and outputs a concatenated result as a cipher text.

A third exemplary aspect of the present invention provides the shared key block cipher apparatus in accordance with the second exemplary aspect, wherein the first hash means compresses the first block by using a polynomial hash function including a secret key as a variable in a finite field; and the second hash means calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

A fourth exemplary aspect of the present invention provides the shared key block cipher apparatus in accordance with one of the first to third exemplary aspects, wherein the unitary block cipher means converts the unitary block intermediate text into the unitary block intermediate cipher text by using a block cipher; and the pseudo random number generating means applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

A fifth exemplary aspect of the present invention provides the shared key block cipher apparatus in accordance with one of the first to third exemplary aspects, wherein the unitary block cipher means converts the unitary block intermediate text into the unitary block intermediate cipher text by using an enhanced block cipher attained by combining a block cipher a plurality of times; and the pseudo random number generating means applies a sum of the unitary block intermediate cipher text and the unitary block intermediate text as an input to expansion processing which employs the block cipher a plurality of times and sets a result of the expansion processing as an intermediate random number.

A sixth exemplary aspect of the present invention provides the shared key block cipher apparatus in accordance with one of the first to third exemplary aspects, wherein the unitary block cipher means converts the unitary block intermediate text into the unitary block intermediate cipher text by using a block cipher; and the pseudo random number generating means inputs a sum of the unitary block intermediate cipher text and the unitary block intermediate text as an initial vector to a stream cipher which receives an initial vector as an additional input to obtain a key stream and sets the key stream as an intermediate random number.

A seventh exemplary aspect of the present invention provides a shared key block cipher method for use in an information processing apparatus including a first hash step of dividing a plain text to be ciphered into a first block and a second block, compressing the divided first block by a hash function, adding the compressed first block to the second block to generate a unitary block intermediate text, and outputting the generated unitary block intermediate text and the first block; a unitary block cipher step of ciphering the unitary block intermediate text to generate a unitary block intermediate cipher text; a pseudo random number generating step of generating an intermediate random number based on a sum of the unitary block intermediate text and the unitary block intermediate cipher text; an adding step of adding the intermediate random number to the first block to output a first addition result; a second hash step of compressing the first addition result by a hash function and calculating a cipher text using the compressed first addition result and the unitary block intermediate cipher text; and a cipher text output step of outputting the cipher text outputted from the second hash step.

An eighth exemplary aspect of the present invention provides the shared key block cipher method in accordance with the seventh exemplary aspect, wherein the second hash step permutes the unitary block intermediate cipher text by a hash function, concatenates a second addition result obtained by adding the permuted unitary block intermediate cipher text to the compressed first addition result with the first addition result, and outputs a concatenated result as a cipher text.

A ninth exemplary aspect of the present invention provides the shared key block cipher method in accordance with the eighth exemplary aspect, wherein the first hash step compresses the first block by using a polynomial hash function including a secret key as a variable in a finite field; and the second hash step calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

A 10th exemplary aspect of the present invention provides the shared key block cipher method in accordance with one of the seventh to ninth exemplary aspects, wherein the unitary block cipher step converts the unitary block intermediate text into the unitary block intermediate cipher text by using a block cipher; and the pseudo random number generating step applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

A 11th exemplary aspect of the present invention provides the shared key block cipher method in accordance with one of the seventh to ninth exemplary aspects, wherein the unitary block cipher step converts the unitary block intermediate text into the unitary block intermediate cipher text by using an enhanced block cipher attained by combining a block cipher a plurality of times; and the pseudo random number generating step applies a sum of the unitary block intermediate cipher text and the unitary block intermediate text as an input to expansion processing which employs the block cipher a plurality of times and sets a result of the expansion processing as an intermediate random number.

A 12th exemplary aspect of the present invention provides the shared key block cipher method in accordance with one of the seventh to ninth exemplary aspects, wherein the unitary block cipher step converts the unitary block intermediate text into the unitary block intermediate cipher text by using a block cipher; and the pseudo random number generating step inputs a sum of the unitary block intermediate cipher text and the unitary block intermediate text as an initial vector to a stream cipher which receives an initial vector as an additional input to obtain a key stream and sets the key stream as an intermediate random number.

A 13th exemplary aspect of the present invention provides a shared key block cipher program to be executed in an information processing apparatus, including first hash processing for dividing a plain text to be ciphered into a first block and a second block, compressing the divided first block by a hash function, adding the compressed first block to the second block to generate a unitary block intermediate text, and outputting the generated unitary block intermediate text and the first block; unitary block cipher processing for ciphering the unitary block intermediate text to generate a unitary block intermediate cipher text; pseudo random number generating processing for generating an intermediate random number based on a sum of the unitary block intermediate text and the unitary block intermediate cipher text; adding processing for adding the intermediate random number to the first block to output a first addition result; second hash processing for compressing the first addition result by a hash function and calculating a cipher text using the compressed first addition result and the unitary block intermediate cipher text; and cipher text output processing for outputting the cipher text outputted from the second hash processing.

A 14th exemplary aspect of the present invention provides the shared key block cipher program in accordance with the 13th exemplary aspect, wherein the second hash processing permutes the unitary block intermediate cipher text by a hash function, concatenates a second addition result obtained by adding the permuted unitary block intermediate cipher text to the compressed first addition result with the first addition result, and outputs a concatenated result as a cipher text.

A 15th exemplary aspect of the present invention provides the shared key block cipher program in accordance with the 14th exemplary aspect, wherein the first hash processing compresses the first block by using a polynomial hash function including a secret key as a variable in a finite field; and the second hash processing calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

A 16th exemplary aspect of the present invention provides the shared key block cipher program in accordance with one of the 13th to 15th exemplary aspects, wherein the unitary block cipher processing converts the unitary block intermediate text into the unitary block intermediate cipher text by using a block cipher; and the pseudo random number generating processing applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

A 17th exemplary aspect of the present invention provides the shared key block cipher program in accordance with one of the 13th to 15th exemplary aspects, wherein the unitary block cipher processing converts the unitary block intermediate text into the unitary block intermediate cipher text by using an enhanced block cipher attained by combining a block cipher a plurality of times; and the pseudo random number generating processing applies a sum of the unitary block intermediate cipher text and the unitary block intermediate text as an input to expansion processing which employs the block cipher a plurality of times and sets a result of the expansion processing as an intermediate random number.

An 18th exemplary aspect of the present invention provides the shared key block cipher program in accordance with one of the 13th to 15th exemplary aspects, wherein the unitary block cipher processing converts the unitary block intermediate text into the unitary block intermediate cipher text by using a block cipher; and the pseudo random number generating processing inputs a sum of the unitary block intermediate cipher text and the unitary block intermediate text as an initial vector to a stream cipher which receives an initial vector as an additional input to obtain a key stream and sets the key stream as an intermediate random number.

A 19th exemplary aspect of the present invention provides a recording medium for recording therein the shared key block cipher program in accordance with one of the 13th to 18th exemplary aspects.

### ADVANTAGES OF THE INVENTION

According to the present invention, by combining a block cipher safe against the chosen cipher text attack with a cipher function safe against the known plain text attack, the number of calls of the block cipher safe against the chosen cipher text attack is only one for each one-block cipher regardless of the block size; hence, if the hash function employed in the first and second hash means has a sufficient high speed, throughput of the cipher is, for the large block size, almost equal to throughput of the cipher function safe against the known plain text attack, and it is therefore possible to provide an arbitrary block cipher having a large block size which is safe against the chosen cipher text attack.

### BEST MODE FOR CARRYING OUT THE INVENTION

First, referring to FIG. 1, description will be given of a shared key block cipher apparatus in accordance with an exemplary embodiment.

A shared key block cipher apparatus according to an exemplary embodiment includes, as FIG. 1 shows, plain text input means 101 for inputting a plain text to be ciphered, first hash means 102 for dividing the plain text into a PA block and a PB block, compressing the divided PB block by an AXU hash function H1, generating a unitary block intermediate text by adding the compressed PB block to the PA block, and outputting the generated unitary block intermediate text and the PB block; unitary block cipher means 103 for ciphering the unitary block intermediate text to generate a unitary block intermediate cipher text, pseudo random number generating means 104 for generating an intermediate random number from the unitary block intermediate cipher text and the unitary block intermediate text, adding means 105 for adding the intermediate random number to the PB block to output an addition result, second hash means 106 for compressing the addition result of the adding means 105 using an AXU hash function H2 independent of the AXU hash function H1, concatenating a result of addition obtained by adding the compressed addition result to a result obtained by converting the unitary block intermediate cipher text using an AXU permutation G3 independent of the AXU hash functions H1 and H2 with the addition result of the adding means 105 and outputting a result of concatenation as a cipher text, and cipher text output means 107 for outputting the cipher text. As a result, it is possible to provide a secure block cipher by combining cipher components safe against the chosen plain text/cipher text attack with cipher components safe against the known plain text attack.

### First Exemplary Embodiment

First, referring to FIG. 1, description will be given of structure of a shared key block cipher apparatus according to a first exemplary embodiment. FIG. 1 is a block diagram showing the structure of the shared key block cipher apparatus according to the first exemplary embodiment.

The shared key block cipher apparatus according to the first exemplary embodiment includes plain text input means 101, first hash means 102, unitary block cipher means 103, pseudo random number generating means 104, adding means 105, second hash means 106, and cipher text output means 107.

The shared key block cipher apparatus in the first exemplary embodiment may be implemented by a CPU, a memory, and a disk. Each means of the shared key block cipher apparatus is implemented such that a program to achieve each means described above is stored in the disk and the CPU executes the stored program.

Next, description will be given of each means of the shared key block cipher apparatus.

### <Plain Text Input Means 101>

The plain text input means 101 inputs a plain text as an object of cipher. For example, it is realized by a character input device such as a keyboard.

### <First Hash Means 102>

The first hash means 102 divides the plain text inputted from the plain text input means 101 into a PA block and a PB block, compresses the divided PB block by a hash function, and adds the compressed PB block to the PA block. And the first hash means 102 concatenates a sum of the PB block compressed by the hash function and the PA block not compressed by a hash function with the PB block before the compression thereof by the hash function and outputs a concatenated result.

Conditions of the first hash means 102 will be described below. Assume that the entire plain text has a block size of nm bits (where, m is an integer equal to or more than two) and the unitary block intermediate text to be inputted to the unitary block cipher means 103 has a bit width of n. Assume that a function to extract left-side n bits (PA block) of the input is left and a function to extract right-side n(m−1) bits (PB block) of the input is right. Assuming that the first hash means 102 is G1, it is required that G1 is a keyed nm-bit permutation and probability of left(G1(x))=left(G1(x′) is small for two arbitrary, different input lengths x and x′.

Actually, the first hash means 102 can be implemented by a keyed hash function having a property called “almost XOR universal” (to be referred to as AXU hereinbelow). This means that for two different inputs to the keyed hash function, the sum of outputs from the hash function for the respective inputs distributes uniformly. Such hash function H is generally called a universal hash function and can be implemented by using, for example, a product in a finite field and Multimodular Hash Function described in Non-patent Document 4.

Concretely, it is implementable by the Feistel-type permutation using an AXU hash function. In this connection, assuming that an AXU hash function with an n(m−1)-bit input and an n-bit output is H1, the output from the first hash means 102 for an input length of x is represented by expression (1).

G1(x)=(left(x)+H1(right(x))∥right(x)). (1)

wherein, left(x)+H1(right(x)) is a unitary block intermediate text.

The plus symbol indicates an exclusive logical sum. For example, assuming that right(x) is represented as right(x)=(r_{—}1, . . . r_[m−1]) using an n-bit vector r_{—}1, . . . r_[m−1], H1 can be implemented by a polynomial calculation in a finite field by using an n-bit secret key K1 as a variable and an n-bit vector r_{—}1, . . . r_[m−1] as a coefficient. Specifically, it is expression (2).

H1(right(x))=mul(r_{—}[m−1],K1̂[m−1])+mul(r_{—}[m−2],K1̂[m−2])+ . . . +mul(r_{—}[1],K1) (2)

wherein, K1̂[i] indicates the i-th power of K1 and mul(a,b) represents a product between a variable a and a coefficient b in a finite field. An algorithm to produce the product at a high speed is described, for example, in Non-patent Document 5.

### <Unitary Block Cipher Means 103>

The unitary block cipher means 103 generates a cipher text of the unitary block intermediate cipher text, namely, a unitary block intermediate cipher text. The unitary block intermediate cipher text is realizable by, for example, a block cipher safe against the chosen cipher text attack such as the Advanced Encryption Standard (AES) described in Non-patent Document 6 or a serial concatenation thereof.

### <Pseudo Random Number Generating Means 104>

The pseudo random number generating means 104 generates an intermediate random number based on the unitary block intermediate text and the unitary block intermediate cipher text and the sum thereof.

In the pseudo random number generating means 104, a random number generator to which the sum of the unitary block intermediate text and the unitary block intermediate cipher text are inputted is required to be safe against the known plain text attack. That is, it is only needed that when an attacker obtains an intermediate random number in a model in which the attacker can randomly choose an input, it is difficult to discriminate the intermediate random number from the true random number. In general, in the random number generator adopted in the pseudo random number generating means 104, the output length is remarkably longer than the input length; however, by using the schemes of Patent Document 1 and Non-Patent Document 8, such processing can be implemented on the basis of a function which is safe against the known plain text attack and which has an output width of a fixed and small value.

Also, the random number generator used in the pseudo random number generating means 104 can be realized by a stream cipher having an additional input called an initial vector. Such stream cipher can be realized, for example, by the stream cipher SEAL described in Non-Patent Document 8.

### <Adding Means 105>

The adding means 105 adds the intermediate random number to a part of the plain text, i.e., the PB block. If the entire plain text has a block size of nm bits, the PB block corresponds to the right-side n(m−1) bits.

### <Second Hash Means 106>

The second hash means 106 attains a cipher text as an output by use of the output from the adding means 105 and the unitary block intermediate cipher text.

Conditions of the second hash means 106 are as follows. Assume that the overall plain text has a block size of nm bits (where, m is an integer equal to or more than two) and the unitary block intermediate text to be inputted to the unitary block cipher means 103 has a bit width of n. Assume that the function to extract the left-side n bits (the unitary block intermediate cipher text) from the input is left and the function to extract the right-side n(m−1) bits (the addition result by the adding means 105) from the input is right. Assume that the first hash means 102 is G1 and the second hash means 106 is G2. Assume that both of G1 and G2 are keyed nm bit permutations, and inverse functions respectively thereof are G1̂[−1] and G2̂[−1].

In this situation, for two arbitrary, different input lengths x and x′ for G1 and two arbitrary, different input lengths y and y′ for G2̂[−1], both of probability for left(G1(x)+G2̂[−1](y))=left(G1(x′)+G2̂[−1](y′)) and probability for left(G2̂[−1](y))=left(G2̂[−1](y′)) are required to be small. Correctly, these are conditions assumed in consideration of both of G1 and G2.

Specifically, assuming that the first hash means 102 is a Feistel-type permutation by the AXU hash function H1, the second hash means 106 is represented by expression (3).

G2(x)=G3(left)x))+H2(right(x))∥right(x)) (3)

wherein, ∥ denotes a concatenation of sequences. H2 is an n(m−1)-bit input and n-bit output AXU hash function independent of H1. Also, G3 is required to be an n-bit AXU permutation. This indicates that for arbitrary c and two different n-bit input lengths z and z′, probability for G3(z)−G3(z′)=c is reduced. This can be implemented, for example, by setting the key of G3 to a random number K3 which uniformly takes an n-bit independent value other than zero and also setting G3(z)=mul(z,K3). Incidentally, mul(a,b) represents a product in a finite field GF(2̂n).

If the first hash means 102 implements H1 represented by expression (2) by use of the secret key K1 and employs it in expression (1), the second hash means 106 can be realized by assuming in expression (3) that H2 is the same function as H1 of expression (2) using the same secret key K1 as G1 and by setting the AXU permutation as G3(left(x))=mul(left(x),K1̂ [m]). However, in this situation, the secret key K1 must be a random number which uniformly takes a value other than zero.

### <Cipher Text Output Means 107>

The cipher text output means 107 outputs as a cipher text the output result inputted from the second hash means 106. It is implementable by using a computer display and a printer.

Subsequently, referring to FIG. 2, description will be given of processing operation of the shared key block cipher apparatus according to the first exemplary embodiment shown in FIG. 1.

First, the plain text input means 101 inputs a plain text (PA block and PB block) to be ciphered to the first hash means 102 (step A1).

The first hash means 102 divides the plain text (PA block and PB block) inputted from the plain text input means 101 into a PA block and a PB block, compresses the divided PB block by an AXU hash function H1, adds the compressed PB block to the PA block to generate a unitary block intermediate text, and outputs the generated unitary block intermediate text and the PB block (step A2).

The unitary block cipher means 103 encrypts the unitary block intermediate text inputted from the first hash means 102 to generate a unitary block intermediate cipher text and outputs the generated unitary block intermediate cipher text to the pseudo random number generating means 104 and the second hash means 106 (step A3).

The pseudo random number generating means 104 generates an intermediate random number based on the unitary block intermediate text and the unitary block intermediate cipher text inputted from the unitary block cipher means 103 and outputs the generated intermediate random number to the adding means 105 (step A4).

The adding means 105 conducts an adding process between the intermediate random number inputted from the pseudo random number generating means 104 and the PB block inputted from the first hash means 102 and outputs the sum obtained from the adding process to the second hash means 106 (step A5).

The second hash means 106 converts the unitary block intermediate cipher text inputted from the unitary block cipher means 103 by use of the AXU permutation G3 (step A6) and concatenates an addition result obtained by adding the unitary block intermediate cipher text converted by the AXU permutation G3 to the addition result which is inputted from the adding means 105 and which is compressed by an AXU hash function H2 with the addition result inputted from the adding means 105 and outputs a concatenated result as a cipher text (step A7).

The cipher text output means 107 outputs the cipher text inputted from the second hash means 106 (step A8).

As a result, the shared key block cipher apparatus according to the exemplary embodiment is capable of implementing a high-speed and safe block cipher for a large block size by combining a block cipher safe against the chosen cipher text attack with a cipher function safe against the known plain text attack. In the shared key block cipher apparatus according to the exemplary embodiment, the number of calls for the block cipher safe against the chosen cipher text attack is only one for one-block encryption regardless of the block size; hence, if the hash function adopted in the first and second hash means has sufficiently a high speed, throughput of the encryption for a large block size is almost equal to throughput of the function safe against the known plain text attack. The hash functions employed in the shared key block cipher apparatus according to the exemplary embodiment needs only to satisfy the universality; such hash functions can be remarkably increased in the speed as compared with the ordinary shared key cipher by use of an existing high-speed finite-field operation algorithm and the like. Since the known plain text attack is weaker than the chosen plain text attack, the function safe against the known plain text attack generally operates at a higher speed than the function satisfying safety of a definition weaker than that. Therefore, by combining the block cipher with its short stage, it is possible to construct a block cipher higher in its speed as compared with the conventional cipher operation mode.

Additionally, there have been recently proposed many stream ciphers higher in the speed than the representative block ciphers such as AES; using such ciphers by combining them with AES, it is possible to implement a scheme higher in the speed than the AES-based conventional scheme. Contrarily, in a situation wherein a concatenated block cipher in which an existing block cipher is serially concatenated by changing the key is combined with the block cipher itself to be applied to the shared key block cipher apparatus according to the exemplary embodiment; in order to break this, it is required to break the concatenated block cipher by the chosen cipher text attack or to break the block cipher itself by the known plain text attack. It implies that this has a speed equivalent to that of the conventional cipher operation mode and this realizes higher safety than the related art.

This application is based upon and claims the benefit of priority from Japanese patent application No. 2006-294536, filed on Oct. 30, 2006, the disclosure of which is incorporated herein in its entirety by reference.

### INDUSTRIAL APPLICABILITY

The present invention is applicable to a system for conducting cipher communication between two parties, a system to safely distribute contents such as films and music, and uses of file ciphering to safely operate data on a computer server.

### BRIEF DESCRIPTION OF DRAWINGS

FIG. 1 is a block diagram showing a configuration of the shared key block cipher apparatus according to the exemplary embodiment; and

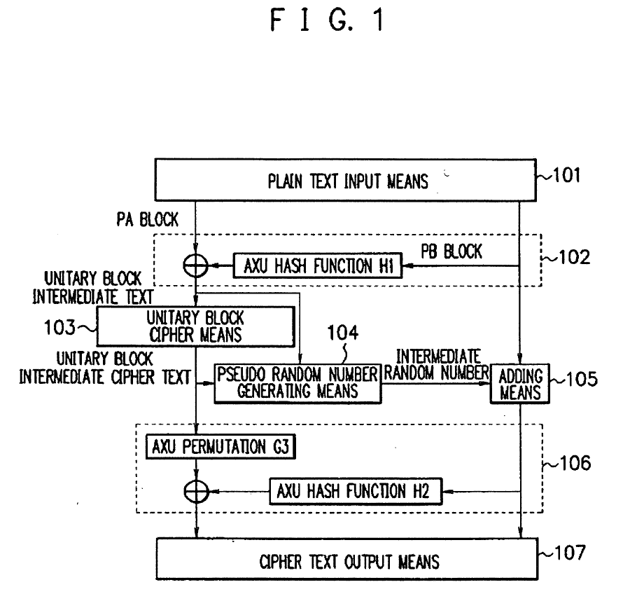

FIG. 2 is a flowchart showing a flow of operation in the shared key block cipher apparatus according to the exemplary embodiment.

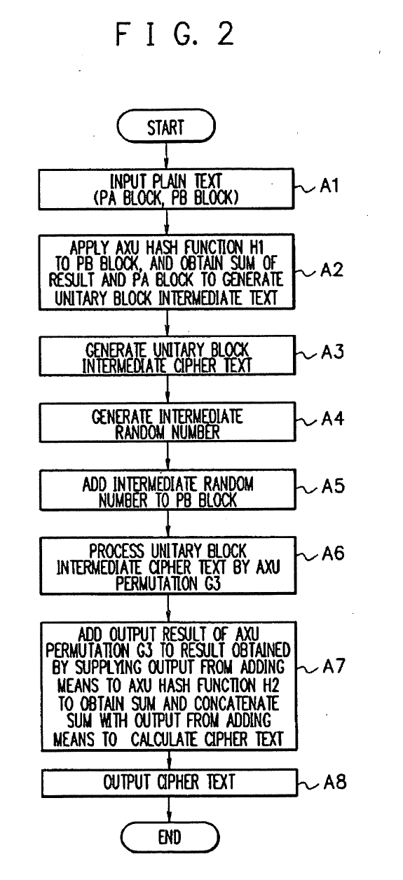

### DESCRIPTION OF REFERENCE NUMERALS

101 Plain text input means
102 First hash means
103 Unitary block cipher means
104 Pseudo random number generating means
105 Adding means
106 Second hash means
107 Cipher text output means

1. A shared key block cipher apparatus comprising: a first hash unit which divides a plain text to be ciphered into a first block and a second block, compresses the divided first block by a hash function, adds the compressed first block to the second block to generate a unitary block intermediate text, and outputs the generated unitary block intermediate text and the first block;
a unitary block cipher unit which ciphers the unitary block intermediate text to generate a unitary block intermediate cipher text;
a pseudo random number generating unit which generates an intermediate random number based on a sum of the unitary block intermediate text and the unitary block intermediate cipher text;
an adding unit which adds the intermediate random number to the first block to output a first addition result;
a second hash unit which compresses the first addition result by a hash function and calculates a cipher text using the compressed first addition result and the unitary block intermediate cipher text; and
a cipher text output unit which outputs the cipher text outputted from the second hash unit.

2. The shared key block cipher apparatus in accordance with claim 1, wherein the second hash unit permutes the unitary block intermediate cipher text by a hash function, concatenates a second addition result obtained by adding the permuted unitary block intermediate cipher text to the compressed first addition result with the first addition result, and outputs a concatenated result as a cipher text.

3. The shared key block cipher apparatus in accordance with claim 2, wherein
the first hash unit compresses the first block by using a polynomial hash function including a secret key as a variable in a finite field; and
the second hash unit calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

4. The shared key block cipher apparatus in accordance with claim 1, wherein
the unitary block cipher unit converts the unitary block intermediate text into the unitary block intermediate cipher text by using a block cipher; and
the pseudo random number generating unit applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

5. The shared key block cipher apparatus in accordance with claim 1, wherein
the unitary block cipher unit converts the unitary block intermediate text into the unitary block intermediate cipher text by using an enhanced block cipher attained by combining a block cipher a plurality of times; and
the pseudo random number generating unit applies a sum of the unitary block intermediate cipher text and the unitary block intermediate text as an input to expansion processing which employs the block cipher a plurality of times and sets a result of the expansion processing as an intermediate random number.

6. The shared key block cipher apparatus in accordance with claim 1, wherein
the unitary block cipher unit converts the unitary block intermediate text into the unitary block intermediate cipher text by using a block cipher; and
the pseudo random number generating unit inputs a sum of the unitary block intermediate cipher text and the unitary block intermediate text as an initial vector to a stream cipher which receives an initial vector as an additional input to obtain a key stream and sets the key stream as an intermediate random number.

7. A shared key block cipher method for use in an information processing apparatus comprising:
a first hash step of dividing a plain text to be ciphered into a first block and a second block, compressing the divided first block by a hash function, adding the compressed first block to the second block to generate a unitary block intermediate text, and outputting the generated unitary block intermediate text and the first block;
a unitary block cipher step of ciphering the unitary block intermediate text to generate a unitary block intermediate cipher text;
a pseudo random number generating step of generating an intermediate random number based on a sum of the unitary block intermediate text and the unitary block intermediate cipher text;
an adding step of adding the intermediate random number to the first block to output a first addition result;
a second hash step of compressing the first addition result by a hash function and calculating a cipher text using the compressed first addition result and the unitary block intermediate cipher text; and
a cipher text output step of outputting the cipher text outputted from the second hash step.

8. The shared key block cipher method in accordance with claim 7 wherein the second hash step permutes the unitary block intermediate cipher text by a hash function, concatenates a second addition result obtained by adding the permuted unitary block intermediate cipher text to the compressed first addition result with the first addition result, and outputs a concatenated result as a cipher text.

9. The shared key block cipher method in accordance with claim 8, wherein
the first hash step compresses the first block by using a polynomial hash function including a secret key as a variable in a finite field; and
the second hash step calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

10. The shared key block cipher method in accordance with claim 7, wherein
the unitary block cipher step converts the unitary block intermediate text into the unitary block intermediate cipher text by using a block cipher; and
the pseudo random number generating step applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

11. The shared key block cipher method in accordance with claim 7, wherein
the unitary block cipher step converts the unitary block intermediate text into the unitary block intermediate cipher text by using an enhanced block cipher attained by combining a block cipher a plurality of times; and
the pseudo random number generating step applies a sum of the unitary block intermediate cipher text and the unitary block intermediate text as an input to expansion processing which employs the block cipher a plurality of times and sets a result of the expansion processing as an intermediate random number.

12. The shared key block cipher method in accordance with claim 7, wherein
the unitary block cipher step converts the unitary block intermediate text into the unitary block intermediate cipher text by using a block cipher; and
the pseudo random number generating step inputs a sum of the unitary block intermediate cipher text and the unitary block intermediate text as an initial vector to a stream cipher which receives an initial vector as an additional input to obtain a key stream and sets the key stream as an intermediate random number.

13. A storage medium for storing a shared key block cipher program to be executed in an information processing apparatus comprising:
first hash processing for dividing a plain text to be ciphered into a first block and a second block, compressing the divided first block by a hash function, adding the compressed first block to the second block to generate a unitary block intermediate text, and outputting the generated unitary block intermediate text and the first block;
unitary block cipher processing for ciphering the unitary block intermediate text to generate a unitary block intermediate cipher text;
pseudo random number generating processing for generating an intermediate random number based on a sum of the unitary block intermediate text and the unitary block intermediate cipher text;
adding processing for adding the intermediate random number to the first block to output a first addition result;
second hash processing for compressing the first addition result by a hash function and calculating a cipher text using the compressed first addition result and the unitary block intermediate cipher text; and
cipher text output processing for outputting the cipher text outputted from the second hash processing.

14. The storage medium for storing the shared key block cipher program in accordance with claim 13, wherein the second hash processing permutes the unitary block intermediate cipher text by a hash function, concatenates a second addition result obtained by adding the permuted unitary block intermediate cipher text to the compressed first addition result with the first addition result, and outputs a concatenated result as a cipher text.

15. The storage medium for storing the shared key block cipher program in accordance with claim 14, wherein
the first hash processing compresses the first block by using a polynomial hash function including a secret key as a variable in a finite field; and
the second hash processing calculates a product between an exponential multiple of the secret key and the unitary block intermediate cipher text, compresses the first addition result by use of a polynomial hash function using a secret key as a variable in a finite field, and adds the calculated product to the compressed first addition result to calculate a second addition result.

16. The storage medium for storing the shared key block cipher program in accordance with claim 13, wherein
the unitary block cipher processing converts the unitary block intermediate text into the unitary block intermediate cipher text by using a block cipher; and
the pseudo random number generating processing applies a sum of the unitary block intermediate cipher text and the unitary block intermediate text as an input to expansion processing which employs a plurality of times a simplified block cipher obtained by simplifying the block cipher and sets a result of the expansion processing as an intermediate random number.

17. The storage medium for storing the shared key block cipher program in accordance with claim 13, wherein
the unitary block cipher processing converts the unitary block intermediate text into the unitary block intermediate cipher text by using an enhanced block cipher attained by combining a block cipher a plurality of times; and
the pseudo random number generating processing applies a sum of the unitary block intermediate cipher text and the unitary block intermediate text as an input to expansion processing which employs the block cipher a plurality of times and sets a result of the expansion processing as an intermediate random number.

18. The storage medium for storing the shared key block cipher program in accordance with claim 13, wherein
the unitary block cipher processing converts the unitary block intermediate text into the unitary block intermediate cipher text by using a block cipher; and
the pseudo random number generating processing inputs a sum of the unitary block intermediate cipher text and the unitary block intermediate text as an initial vector to a stream cipher which receives an initial vector as an additional input to obtain a key stream and sets the key stream as an intermediate random number.

19. (canceled)

20. A shared key block cipher apparatus comprising:
first hash means for dividing a plain text to be ciphered into a first block and a second block, compressing the divided first block by a hash function, adding the compressed first block to the second block to generate a unitary block intermediate text, and outputting the generated unitary block intermediate text and the first block;
unitary block cipher means for ciphering the unitary block intermediate text to generate a unitary block intermediate cipher text;
pseudo random number generating means for generating an intermediate random number based on a sum of the unitary block intermediate text and the unitary block intermediate cipher text;
adding means for adding the intermediate random number to the first block to output a first addition result;
second hash means for compressing the first addition result by a hash function and calculating a cipher text using the compressed first addition result and the unitary block intermediate cipher text; and
cipher text output means for outputting the cipher text outputted from the second hash means.
